(19) United States
(12) Patent Application Publication
(10) Pub. No.: US 2006/0104767 A1
(43) Pub. Date: May 18, 2006

(54) Game rack for an all terrain vehicle

(76) Inventors: Cory Dugger, Waverly, TN (US); Robert Dugger, Waverly, TN (US)

Correspondence Address: WOOD, HERRON & EVANS, LLP, 2700 CAREW TOWER, 441 VINE STREET, CINCINNATI, OH, 45202, US

(21) Appl. No.: 10/979,330

(22) Filed: Nov. 2, 2004

(51) Int. Cl. B60P 9/00

(52) U.S. Cl. 414/462

(57) ABSTRACT

A game rack for hauling larger carcasses using an all terrain vehicle includes a frame that attaches to the ATV and a basket that is pivotally attached to the frame and rotates down and rests on the ground. This allows one to pull the carcass onto the basket. The basket includes an extension portion that improves leverage and enables one to lift the carcass in the basket off the ground and attach the basket to the frame, supporting the carcass above the ground. This does not require any type of wench or any other powered device to lift the carcass off the ground.

### BACKGROUND OF THE INVENTION

One typically hunts deep in the woods away from roads. When hunting larger game such as deer, hauling the carcass back to one's truck or automobile can be problematic. All terrain vehicles (ATV) can be used to haul the game back to the road.

Simply placing the animal carcass, such as a deer, on an ATV can be difficult. Usually they are very heavy and not easily lifted, particularly by a single individual. Further, the carcass on the ATV raises the center of gravity making the ATV less stable. Further, it is difficult to keep the carcass tied to the ATV.

Further, transporting an animal carcass can present issues. There may be little room in te back of a pick-up truck. If a car or an SUV is transporting the carcass, it can create a mess.

### SUMMARY OF THE INVENTION

The object of the present invention is to provide a device which can be attached to an ATV or other vehicle to haul large game carcasses. More particularly, the present invention provides a frame that attaches to the front or rear of an ATV and has a metal basket portion pivotally attached to the frame. One can simply drag the carcass into the basket, rotate the basket portion back onto the frame, and lock it into position holding the game to the rack and off the ground. The rack can be attached to either the front or rear portion of the ATV and enables an individual to easily load a deer carcass to the rack without assistance. The rack can also be attached to a trailer hitch.

The objects and advantages of the present invention will be further appreciated in light of the following detailed description and drawings in which:

### BRIEF DESCRIPTION OF THE DRAWINGS

FIG. 1 is a perspective view of the present invention supporting a deer carcass;

FIG. 2 is a perspective view partially in phantom of the game hauler of the present invention;

FIG. 3 is a side elevational view of the present invention.

FIG. 4 is a perspective view of an alternate embodiment of the present invention.

### DETAILED DESCRIPTION OF THE INVENTION

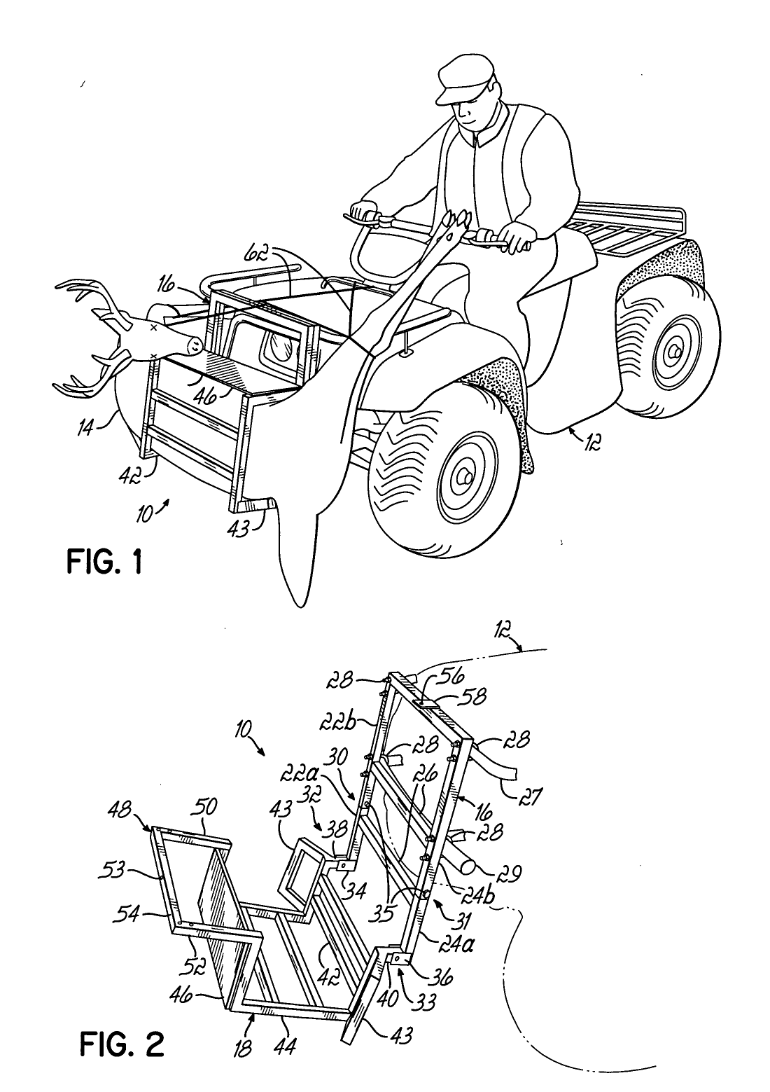

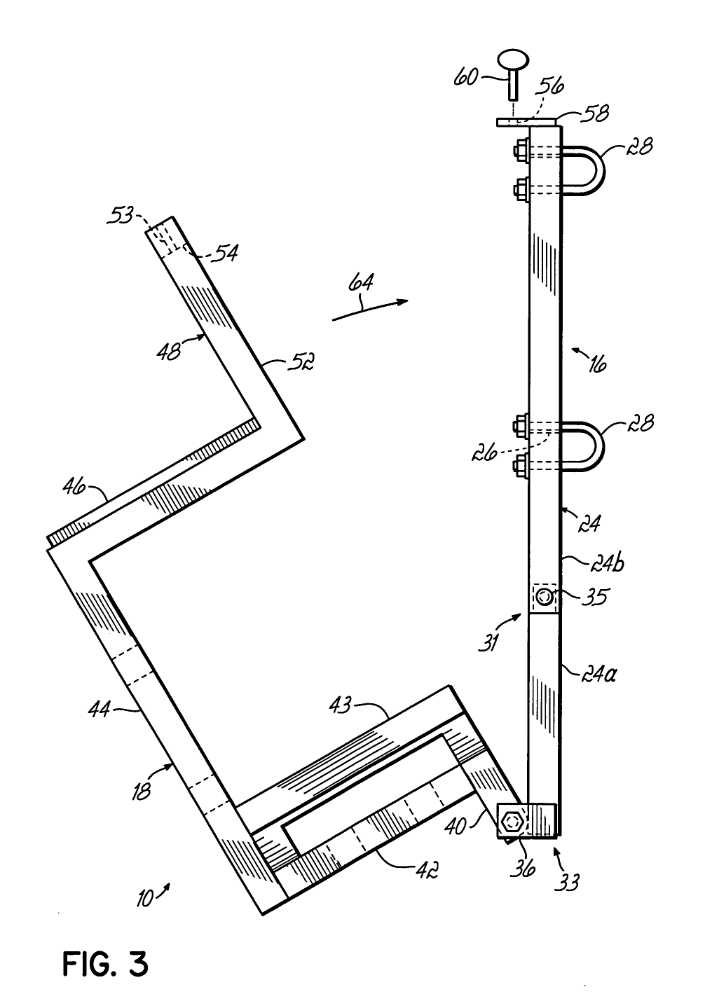

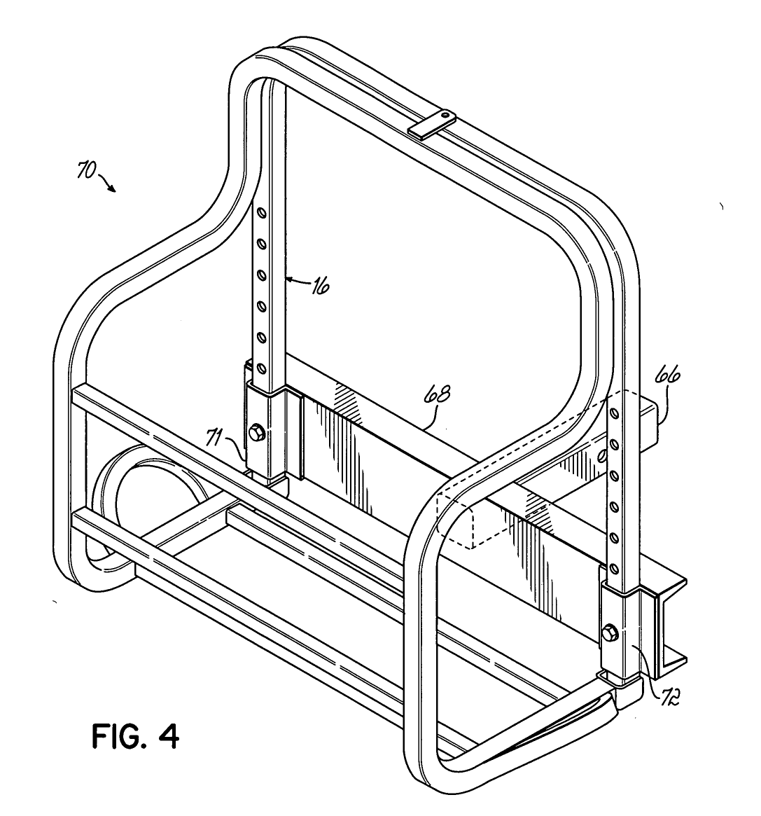

As shown more particularly in FIG. 1, the present invention is a game rack 10 which is adapted to attach to an all terrain vehicle (ATV) 12 and support a large animal carcass, such as a deer 14 shown in FIG. 1.

The game rack 10 includes a frame member 16 and a basket member 18 which is adapted to hold and support the carcass. The frame member 16 and the basket 18 are preferably formed from welded rectangular metal stock. The rack can also be formed from plastic or other high strength materials.

The frame member 16 includes left and right vertical bars 22,24 with a plurality of cross members 26. The vertical bars 22,24 are attached to frame portions 27,29 of the ATV 12 with, for example, U-bolts 28. The vertical bars 22,24 can also be separated at connection points 30,31. Two pins 35 are used to connect bars 22a,22b and 24a,24b at connection points 30/31 respectively. This allows the device to be easily removed leaving sections 22a and 24a still attached to the ATV. As many ATVs are different, the attachment mechanism must be selected for the particular ATV. Although shown attached to the front of the ATV, it can also be attached to the rear. The frame member 16 further includes left and right bottom portions 32, 33 which include brackets 34, 36 respectively.

The basket 18 includes left and right extensions 38, 40 respectively which pivotally attach to the left and right brackets 34, 36. The basket is generally C shaped and includes a bottom portion 42 with two angled side extensions 43, as well as a middle portion 44 which extends away from the bottom portion 42 and an upper portion 46 parallel to the bottom portion 42. When in the closed position, as shown in FIG. 1, upper portion 46 extends back toward the ATV. Finally, an upper extension 48 extends from the upper portion 46 upwardly parallel to frame 16 when in the closed position as shown in FIG. 1.

The upper extension 48 includes left and right side arm members 50, 52 connected by an upper horizontal member 54. A hole 53 through horizontal member 54 is aligned with a hole 56 in metal plate 58 extended from the upper cross member of frame 16. A metal pin 60 extends through the hole 56 in plate 58 and through the hole 53 in horizontal member 54 to lock the basket 18 to the upper portion of the frame 16. Side arms 50 and 52 include countersunk holes to enable the upper extension to butt against frame 16 without interference from the U-bolts.

To use the game rack 10, the ATV is driven close to the animal carcass 14, pin 60 is removed allowing the basket to rotate at brackets 34, 36 in a direction opposite to that represented by arrow 64. Since the bottom 32 of the frame is raised above the ground so as not to interfere with the ground clearance of the ATV, the basket pivots down until the middle portion 44 of the basket 18 rests on the ground. The carcass 14 is simply dragged onto the middle portion 44. With the carcass in place the upper horizontal member is lifted in the direction of arrow 64 lifting the carcass off the ground. Side arms 50, 52 provide sufficient mechanical advantage to enable an individual to lift the deer without the use of a wench or other device. Further, the deer is only being lifted approximately 12 to 15 inches off the ground.

The horizontal member is then fixed to the frame member with the pin 60 extended through metal plate 58, holding the deer in position. Side extensions 43 provide added support for the deer. Once the deer is in place its legs and head can be tied in position with ropes 62 providing better securement.

FIG. 4 shows an alternate embodiment of the present invention. As shown in FIG. 4, the rack 70 has a rectangular bar 66 which extends from a cross member 68 bolted to frame 16 by two brackets 71 and 72. The bar 66 is sized to fit within a standard trailer hitch. This is optional and can be removed, if desired. This allows the rack to be attached to either an ATV or any vehicle with an appropriate-sized hitch. Thus, the rack of the present invention can be attached to virtually any vehicle that can be driven into the woods. This allows the carcass to be transported outside the vehicle, preventing the inside of the vehicle from becoming bloody.

This has been a description of the present invention along with the preferred method of practicing the present invention. However, the invention itself should only be defined by the appended claims, WHEREIN WE CLAIM:

1. A game rack comprising:
a basket member pivotally attached to a vehicle and adapted to pivot toward a surface supporting said vehicle;
said basket member adapted to receive and support an animal carcass on a bottom member;
an extension portion extending from said basket portion, said extension portion adapted to improve leverage and thereby enable one to rotate said basket relative to said vehicle, and hold said basket member in a locked position supporting said basket member and said carcass above said surface.

2. The rack claimed in claim 1 further comprising a frame attached to said vehicle.

3. The rack claimed in claim 2, wherein an upper horizontal portion of said extension portion attaches to an upper portion of said frame to lock said basket in position against said frame.

4. The rack claimed in claim 1, wherein said basket portions includes two side extensions from said bottom member.

5. The rack claimed in claim 2, wherein said rack is attached to the front grill of an all terrain vehicle.

6. The rack claimed in claim 5, wherein said basket rotates from a position above the ground down to a position wherein said basket is resting on said ground.

7. The rack claimed in claim 2, wherein said frame has a bar extended from said frame adapted to fit within a towing hitch.

8. A game rack having a frame adapted to support an animal carcass;
said rack having a connection adapted to attach to a vehicle;
said rack further having a bar adapted to attach to a trailer hitch.
